(19) United States
(12) Patent Application Publication
(10) Pub. No.: US 2021/0029475 A1
(43) Pub. Date: Jan. 28, 2021

(54) CHARGING CONTACT CONNECTION FOR A CHARGER, MATING CONTACT CONNECTION, CHARGING CONTACT SYSTEM AND ELECTRICAL DEVICE

(71) Applicant: SIVANTOS PTE. LTD., Singapore (SG)

(72) Inventors: MUHAMMAD SHAHID BIN SHITH, SINGAPORE (SG); LIT SONG GLEN DING, SINGAPORE (SG); BEATE ANNA MARIA KRAEMER, FUERTH (DE)

(21) Appl. No.: 16/939,395

(22) Filed: Jul. 27, 2020

(30) Foreign Application Priority Data
Jul. 25, 2019 (DE) 102019211043

(51) Int. Cl. H04R 25/00; H01R 13/04; H01R 13/10

(52) U.S. Cl. CPC H04R 25/556; H02J 7/0042; H01R 13/10; H01R 13/04

(57) ABSTRACT

A charging contact connection is provided for a charger, in particular for a hearing device. The charging contact connection contains a permanent magnetic magnet element for magnetically attracting a mating contact connection, a central contact pin for making contact with a first mating contact of the mating contact connection and a contact casing, annularly surrounding the central contact pin, that has a contact surface for making contact with a second mating contact of the mating contact connection, which contact surface is oriented obliquely and/or perpendicularly with respect to a longitudinal axis of the contact pin. The contact casing is electrically insulated from the contact pin, and the contact casing at least partially surrounds the magnet element.

### CROSS-REFERENCE TO RELATED APPLICATION

This application claims the priority, under 35 U.S.C. § 119, of German application DE 10 2019 211 043, filed Jul. 25, 2019; the prior application is herewith incorporated by reference in its entirety.

### BACKGROUND OF THE INVENTION

### Field of the Invention

The invention relates to a charging contact connection for a charger that is used for charging an electrical device, in particular a hearing device. In addition, the invention relates to a mating contact connection that, in particular, forms the counterpart for the charging contact connection. Additionally, the invention relates to a charging contact system and an electrical device, in particular a hearing device.

Devices that are operated with rechargeable batteries frequently have connections in order to make electrical contact with a charger and hence to be able to leave the rechargeable batteries inside the device when charging them. Often, proprietary connections are used for this. From the cell phone sector, however, it is now known that a large number of suppliers are resorting to standard systems. In some cases, devices having rechargeable batteries also use what are known as jack plugs. These systems frequently have the disadvantage that the insertion distances required for making the contact are usually comparatively long, and finding and easily connecting the corresponding connections, in particular in chargers having charging cradles, as “blindly” as possible is therefore hampered. Spring contacts of comparatively flat design are therefore often used in this area. These are known from the field of cordless landline telephones, for example.

The invention is based on the object of simplifying making contact with corresponding charging contacts.

### BRIEF SUMMARY OF THE INVENTION

This object is achieved according to the invention by a charging contact connection having the features of the independent charging contact connection claim. In addition, this object is achieved according to the invention by a mating contact connection having the features of the mating contact connection claim. Further, the object is achieved according to the invention by a charging contact system having the features of the independent charging contact system claim. Additionally, this object is achieved according to the invention by an electrical device, in particular a hearing device, having the features of the independent hearing device claim. Further advantageous and in some cases inherently inventive embodiments and further developments are presented in the subclaims and the description that follows.

The inventive charging contact connection is configured and intended for use in a charger. This charger is used in particular for charging an electrical device (operated by means of a rechargeable battery), in particular a hearing device, preferably a hearing aid for looking after a person having impaired hearing. The charging contact connection has a permanent magnetic magnet element for magnetically attracting a mating contact connection (in particular of the hearing device). In addition, the charging contact connection has a central contact pin that is used for making contact with a first mating contact of the mating contact connection. Further, the charging contact connection has a contact casing, annularly surrounding the central contact pin, that contains a contact surface for making contact with a second mating contact of the mating contact connection, which contact surface is oriented obliquely and/or perpendicularly with respect to a longitudinal axis of the contact pin. The contact casing is electrically insulated from the contact pin. Additionally, the contact casing at least partially surrounds the magnet element.

The two connection contacts formed by the contact pin and the contact casing are therefore nested in one another, so that the physical size of the charging contact connection can advantageously be reduced. The magnet element also allows the charging contact connection and the mating contact connection to need only be positioned “close” to one another in order to make contact. At a sufficiently short distance, the magnetic attraction allows almost automatic coupling of the mutually assigned connection contacts.

Preferably, the contact pin is in the form of a spring contact pin. In particular, the contact pin in this case has a spring-mounted contact tip and is also referred to as a “pogo pin”. The spring contact pin design allows compensation for tolerances and comparatively failsafe making of contact with the applicable mating contacts.

In a preferred embodiment, at least the contact surface of the contact casing is in a rotationally symmetrical embodiment with respect to the longitudinal axis of the contact pin. The contact pin and the contact surface, in particular the entire contact casing, are therefore arranged concentrically with respect to one another. As a result, any rotational orientation of the charging contact connection with respect to the mating contact connection is rendered possible when making contact.

In a further preferred embodiment, the contact casing surrounds the magnet element in a pot-like manner. Preferably, the contact surface of the contact casing forms the “pot bottom” and a wall section of the contact casing, in particular running parallel to the contact pin, forms the “pot side wall”.

In an expedient embodiment, the magnet element is of electrically conductive design and forms an electrical connection between the contact casing and an electrical line downstream of the charging contact connection. As a result, the component integration of the charging contact connection is increased further and the number of components is accordingly reduced. This also allows installation space to be saved.

In a further expedient embodiment, the magnet element is also preferably in rotationally symmetrical form with respect to the longitudinal axis of the contact pin and surrounds the latter in particular in a sleeve-like manner.

Preferably, at least sections of the magnet element are fitted into the contact casing.

Expediently, the contact pin—in particular in the rotationally symmetrical embodiment of the contact casing—penetrates the contact surface of the contact casing through an assigned opening. In particular, the free end of the contact pin also projects above the contact surface. Expediently, the assigned first mating contact for the contact pin is set back from the second mating contact in this instance, so that in particular the projecting free end (also: “contact end”) of the contact pin exhibits a centering effect when making contact with the mating contact connection.

In a preferred embodiment, the contact pin is covered by insulating material at least in a contact region with respect to the magnet element and with respect to the contact casing. The insulating material preferably forms a sleeve that is pushed over the contact pin. Alternatively, the insulating material is a type of lacquer applied to the contact pin.

In an optional embodiment, the magnet element is in the form of a plastic-bonded permanent magnet.

Preferably, the contact pin and the contact casing are formed from a metal, which is possibly coated (in particular to increase conductivity).

The mating contact connection according to the invention is preferably configured and intended for coupling to the charging contact connection described above. To this end, the mating contact connection has the aforementioned first mating contact for making contact with the contact pin and the second mating contact, annularly surrounding the first mating contact, for making contact with the contact surface of the contact casing. At least the second mating contact is formed from ferrimagnetic or ferromagnetic material. This advantageously allows an external magnetic component, preferably the magnet element arranged in the charging contact connection, to exert a magnetic attraction at least on the second mating contact, so that coupling is simplified and at least a certain level of fixing to one another is made possible. The mating contact connection is additionally configured and intended for installation in the electrical device, in particular the hearing device (specifically the hearing aid).

In an expedient embodiment, the first mating contact is set back from a contact surface (which is configured and intended to bear against the contact surface of the contact casing) of the second mating contact. Additionally or alternatively, the first and second mating contacts are (mechanically) connected to one another by means of an electrically insulating spacer. The latter advantageously prevents a short between the first and second mating contacts. The set-back embodiment of the first mating contact promotes in particular the above-described centering effect of the contact pin that preferably projects over the contact surface of the contact casing.

Preferably, at least sections of the first mating contact are in cup form (i.e in the form of a preferably spherical hollow), so that a contact surface between the free end of the contact pin and the first mating contact is as large as possible.

More preferably, the second mating contact is arranged concentrically with respect to the first mating contact, analogously to the contact casing, and surrounds the first mating contact in an annularly closed manner. This advantageously also allows the two connections to rotate with respect to one another (i.e. in particular about the axis of rotation of the charging contact connection, which is coincident with the contact pin) in the state coupled to the charging contact connection.

The charging contact system according to the invention is accordingly likewise used for charging the electrical device, in particular the aforementioned hearing device, and, to this end, has the above-described charging contact connection and the above-described mating contact connection that is assigned to the electrical device or the hearing device.

Since the charging contact system contains the charging contact connection and the mating contact connection, the charging contact system has the above-described features and advantages of the charging contact connection in equal measure.

The hearing device according to the invention, which preferably forms a hearing aid, has the above-described mating contact connection for making electrical contact with the above-described charging contact connection. The mating contact connection therefore has the first mating contact for making contact with the contact pin and the second mating contact, annularly surrounding the first mating contact, for making contact with the contact surface of the contact casing. At least the second mating contact is formed from ferrimagnetic or ferromagnetic material.

Preferably, the second mating contact is not permanently magnetized. Preferably, the mating contact connection does not have a permanently magnetised element. As a result, influencing of hearing device components (for example microphones and/or loudspeakers) when the hearing device is operating as intended (i.e. not during the charging process) can be advantageously avoided.

In an embodiment that is advantageous in respect of the utilization of available installation space, the mating contact connection is preferably positioned directly on a printed circuit board of the hearing device in the manner of what is known as a “surface mounted device” (“SMD” for short) and is in contact with assigned conductor tracks on the same side of the printed circuit board.

In a further advantageous embodiment, the mating contact connection is set back from an exterior surface of an exterior housing of the hearing device in the direction of the housing interior. This in particular reduces the risk of skin contact with the two mating contacts by the hearing device wearer.

Preferably, the mating contact connection has a diameter of approximately 3-4 millimeters, preferably around 3.5 millimeters for a height of 0.5-2 millimeters, preferably around approximately 1 millimeter. Accordingly, the charging contact connection preferably also has a comparable diameter of the contact casing. The possibly existent projection of the free end of the contact pin is preferably between 0.5 and 1.5 millimeters.

In an embodiment that also forms an independent invention, the charging contact connection is part of a charging cable that is connected or connectable to a power source or a connecting means for a power source. At least in the state connected to the power source or to the connecting means, this charging cable forms the aforementioned charger. By way of example, the connecting means is a power supply unit (possibly a charging power supply unit) that is connectable to a stationary energy supply system and configured to transform the power drawn therefrom into a magnitude required for charging the electrical device (and, in the case of the charging power supply unit, to monitor the charging process). The power source is for example a portable storage battery, also referred to as a “power bank”, or another electrical device that can provide charging power (for example a laptop or the like, which can also supply power to connected electrical devices via a USB port). In particular if the mating contact connection is installed in a hearing device, the power source can also be formed by what is known as a “neckband”, a type of necklace or the like that contains an additional storage battery and that is connectable to the charging cable.

In an embodiment that likewise forms an independent invention, the charging contact connection is part of a portable (rechargeable) battery module. This can be connected by means of the charging contact connection to the electrical device that has the mating contact connection, in particular the hearing aid, as a type of extension. Optionally, the battery module is equipped with a fast charge function that allows comparatively fast power transmission from the battery module to the energy storage element of the electrical device, in particular of the hearing device. Alternatively, the battery module is configured to remain on the electrical device, in particular the hearing device, as a type of “attachment” as a type of “emergency power source” for further operation (i.e until stationary charging of the electrical device is possible again).

Other features which are considered as characteristic for the invention are set forth in the appended claims.

Although the invention is illustrated and described herein as embodied in a charging contact connection for a charger, a mating contact connection, a charging contact system and an electrical device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a hearing device having a mating contact connection for connecting a charging contact connection for charging a rechargeable battery installed in the hearing device according to the invention;

FIG. 2 is a schematic detail view of the hearing device showing the mating contact connection;

FIG. 3 is a schematic perspective view of the hearing device and the charging contact connection for making contact with the mating contact connection;

FIG. 4 is a perspective, individual-part view of the mating contact connection;

FIG. 5 is a perspective view of the charging contact connection in line with FIG. 4;

FIG. 6 is a schematic partial sectional view of the charging contact system, formed from the charging contact connection and the mating contact connection, in the coupled state;

FIG. 7 is an exploded, perspective view of the charging contact system; and

FIGS. 8 and 9 are perspective views of the hearing device with different exemplary applications of the charging contact system.

### DETAILED DESCRIPTION OF THE INVENTION

Mutually corresponding parts are provided with the same reference signs throughout the figures.

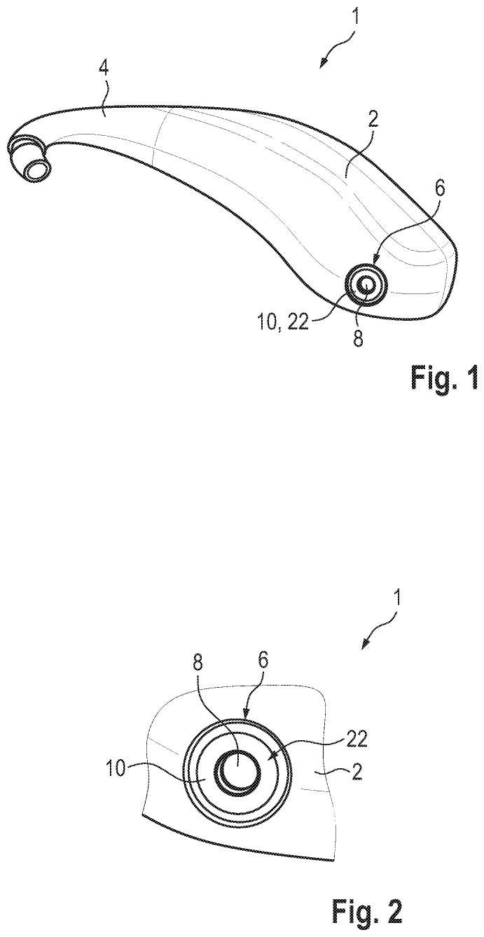

Referring now to the figures of the drawings in detail and first, particularly to FIG. 1 thereof, there is shown a hearing device 1. The hearing device 1 has an exterior housing 2 and a support hook 4 fastened thereto. For its electrical components (microphones, a loudspeaker, a signal processor and possibly a communication module, which are not depicted in more detail) to operate, the hearing device 1 has a rechargeable battery. So as not to have to remove the latter from the exterior housing 2 for charging purposes, the hearing device 1 has a charging connection 6 that forms a mating contact connection with respect to a charging contact connection, which is described in more detail below. In addition, the hearing device 1 also has charging electronics assigned to the rechargeable battery, the charging electronics being configured to monitor the charging process and the state of charge of the battery.

The charging connection 6 has two contact elements arranged concentrically with respect to one another, specifically a central first contact piece 8 and a second contact piece 10 annularly surrounding the latter (see FIGS. 2 and 4). The first and second contact pieces 8, 10 each form a mating contact for corresponding contact elements of the charging contact connection.

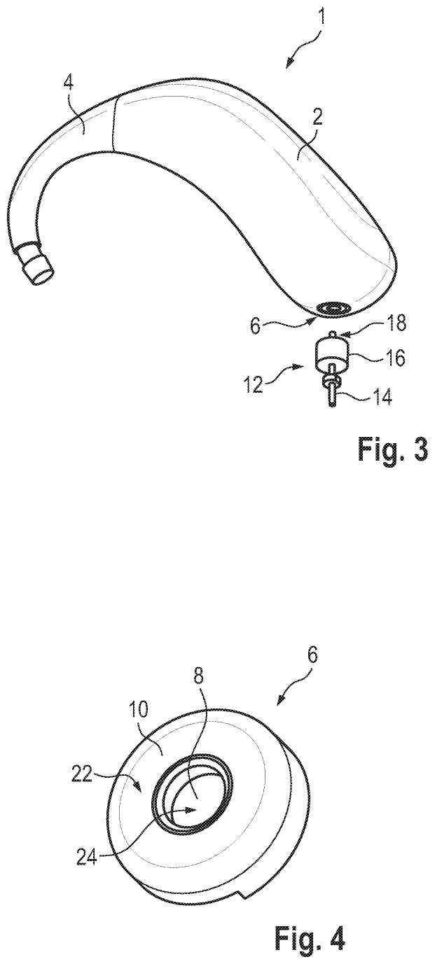

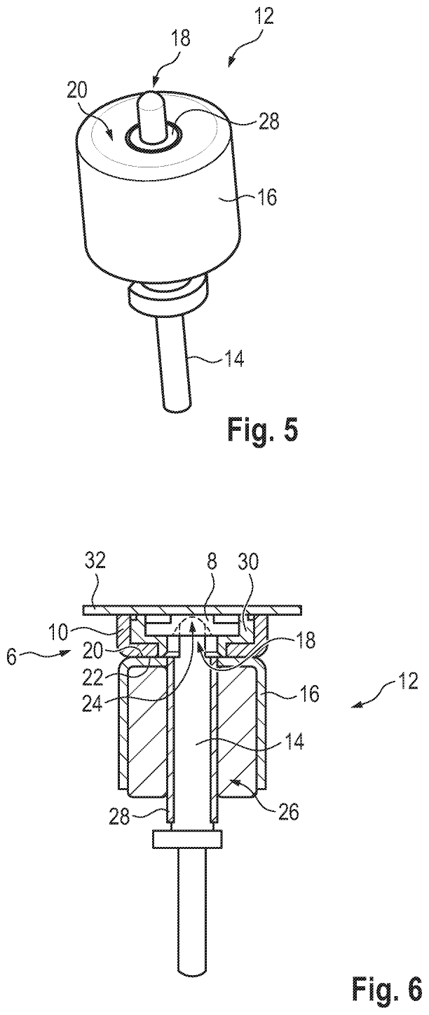

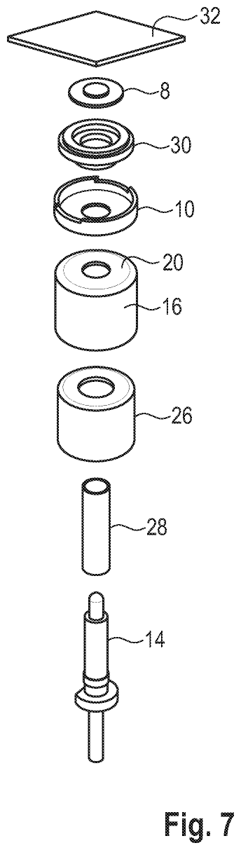

As can be seen from FIGS. 3 and 5, the charging contact connection (referred to as “charging connector” 12 below for short) likewise has two contact elements in rotationally symmetrical form that are arranged concentrically with respect to one another. These are a centrally arranged contact pin 14, specifically a spring contact pin (also: “pogo pin”), and a contact casing 16 surrounding the contact pin in the manner of a sleeve. The free end of the contact pin 14 has a contact end 18 projecting above a contact surface 20 of the contact casing 16. The contact surface 20 is oriented perpendicularly with respect to the longitudinal extent or longitudinal axis of the contact pin 14.

The contact surface 20 of the charging connector 12 bears against a corresponding contact surface 22 of the charging connection 6 in an intended coupling state (see FIG. 6). The contact end 18 is embedded in a cup-like contact hollow 24 of the first contact piece 8 in this case. The first contact piece 8 is set back from the contact surface 22 of the second contact piece 10. As a result, the contact end 18 of the contact pin 14 exhibits a centering effect when the charging connector 12 is coupled to the charging connection 6.

In order to assist the coupling of the charging connector 12 to the charging connection 6, and in order to keep them against one another during the charging process, the charging connector 12 has a magnet element in the form of a magnet sleeve 26. The latter is fitted into the contact casing 16 shaped in a pot-like manner and is put onto the contact pin 14 with said contact casing (see FIG. 6). The magnet sleeve 26 is in permanent magnetic and electrically conductive form. On account of the electrical conductivity of the magnet sleeve 26, the contact casing 16 can make contact with an electrical line assigned to the charging connector 12 while saving installation space and additional components. To insulate the contact casing 16 and the magnet sleeve 26 from the contact pin 14, an electrically insulating material in the form of an insulating sleeve 28 is placed onto said contact pin.

The second contact piece 10 (optionally also the first contact piece 8) is formed from a ferrimagnetic or ferromagnetic material, so that the magnet sleeve 26 can exert a magnetic attraction on said contact piece.

To electrically insulate the first and second contact pieces 8, 10 from one another, an insulating ring 30 is arranged between them as an insulating spacer. The insulating ring is a plastic injection molded part. In an optional variant, this insulating ring 30 contains ferrimagnetic or ferromagnetic material. In this case, the second contact piece 10 can also be in nonmagnetic form.

As FIG. 6 also shows, the charging connection 6 is arranged directly on a printed circuit board 32 of the hearing device 1 and is in contact with corresponding conductor tracks of this printed circuit board 32 in the manner of an SMD. Specifically, the first contact piece 8 and the second contact piece 10 are each directly conductively connected to corresponding conductor tracks of the printed circuit board 32.

The charging connector 12, in a variant application, is integrated in a charger that has a charging cradle for receiving the hearing device 1.

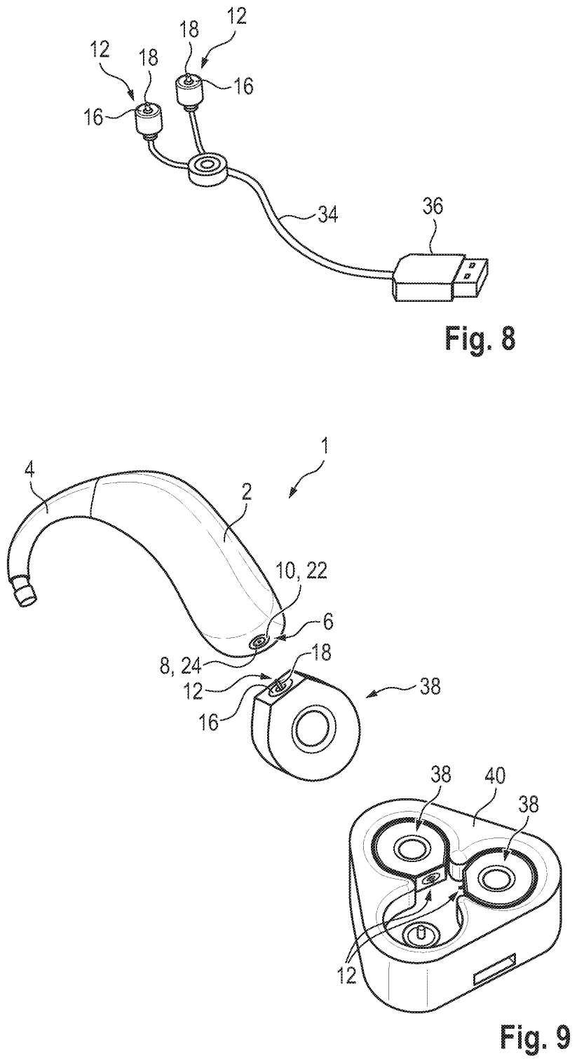

In an alternative variant application, schematically depicted in FIG. 8, the charging connector 12 is an end piece of a charging cable 34 by means of which a power source (for example a power bank, a laptop, a neckband, a charging power supply unit for connection to a stationary power supply system or the like) is connected to the hearing device 1. Specifically, the charging cable 34 depicted is in Y form, a charging connector 12 (for connection to a respective hearing device 1) being arranged on each of the two Y limbs and a USB connector 36 for connection to the power source being arranged at the other end.

FIG. 9 schematically depicts a further variant of an application of the charging connector 12. The charging connector 12 in this instance is integrated directly in a battery pack 38 that can be coupled to the hearing device 1 by means of the charging connector 12 and the charging connection 6 for the purpose of charging and/or maintaining operation of the hearing device 1. Additionally, FIG. 9 also depicts a charging cradle 40 for multiple such battery packs 38. In the application depicted, the charging cradle 40 likewise has a charging connector 12 arranged in it for each battery pack 38, the charging connector making an electrical connection to a charging connection 6 (not depicted) arranged in the respective battery pack 38 at the side for the purpose of charging the battery pack 38.

In all of the depicted variants, the rotationally symmetrical designs of the charging connector 12 and the charging connection 6 allow freely rotatable positioning of the hearing device 1 with respect to the charging connector 12. The magnet sleeve 26 additionally simplifies the coupling of the charging connector 12 to the charging connection 6.

The subject matter of the invention is not restricted to the exemplary embodiment described above. Rather, further embodiments of the invention can be derived from the description above by a person skilled in the art.

The following is a summary list of reference numerals and the corresponding structure used in the above description of the invention:
1 hearing device
2 exterior housing
4 support hook
6 charging connection
8 contact piece
10 contact piece
12 charging connector
14 contact pin
16 contact casing
18 contact end
20 contact surface
22 contact surface
24 contact hollow
26 magnet sleeve
28 insulating sleeve
30 insulating ring
32 printed circuit board
34 charging cable
36 USB connector
38 battery pack
40 charging cradle

1. A charging contact connection for a charger of an electrical device, the charging contact connection comprising:
a permanent magnetic magnet element for magnetically attracting a mating contact connection;
a central contact pin for making contact with a first mating contact of the mating contact connection; and
a contact casing, annularly surrounding said central contact pin, and having a contact surface for making contact with a second mating contact of the mating contact connection, said contact surface being oriented obliquely and/or perpendicularly with respect to a longitudinal axis of said central contact pin, wherein said contact casing being electrically insulated from said contact pin, and wherein said contact casing at least partially surrounding said permanent magnetic magnet element.

2. The charging contact connection according to claim 1, wherein at least said contact surface of said contact casing is rotationally symmetrical with respect to the longitudinal axis of said central contact pin.

3. The charging contact connection according to claim 1, wherein said contact casing surrounds said permanent magnetic magnet element in a pot-shaped manner.

4. The charging contact connection according to claim 1, wherein said permanent magnetic magnet element is of an electrically conductive configuration and forms an electrical connection between said contact casing and an electrical line downstream of the charging contact connection.

5. The charging contact connection according to claim 1, wherein said permanent magnetic magnet element surrounds said central contact pin in a sleeve-shaped manner.

6. The charging contact connection according to claim 1, wherein said central contact pin penetrates said contact surface of said contact casing through an assigned opening and a free end of said central contact pin projects above said contact surface.

7. The charging contact connection according to claim 1, further comprising an insulating material, said central contact pin is covered by said insulating material at least in a contact region with respect to said permanent magnetic magnet element and said contact casing.

8. The charging contact connection according to claim 1, wherein the electrical device is a hearing device.

9. The charging contact connection according to claim 1, further comprising a sleeve formed from an insulating material, wherein said central contact pin is covered by said sleeve, at least in a contact region with respect to said permanent magnetic magnet element and said contact casing.

10. A mating contact connection for installation in an electrical device, comprising:
a first mating contact for making contact with a contact pin of a charging contact connection; and
a second mating contact, annularly surrounding said first mating contact, for making contact with a contact surface of a contact casing of the charging contact connection, wherein at least said second mating contact is formed from ferrimagnetic or ferromagnetic material.

11. The mating contact connection according to claim 10, wherein said first mating contact is set back from a contact surface of said second mating contact, and/or wherein said first and second mating contacts are connected to one another by means of an electrically insulating spacer.

12. A charging contact system for an electrical device, comprising:
a charging contact connection according to claim 1; and
a mating contact connection according to claim 10.

13. An electrical device, comprising:
a charging contact connection according to claim 1; and
a mating contact connection for making electrical contact with said charging contact connection, wherein said mating contact connection having a first mating contact for making contact with said central contact pin and a second mating contact, annularly surrounding said first mating contact, for making contact with said contact surface of said contact casing, wherein at least said second mating contact is formed from ferrimagnetic or ferromagnetic material.
